(19) United States
(12) Patent Application Publication
(10) Pub. No.: US 2026/0260260 A1
(43) Pub. Date: Sep. 3, 2026

(54) System and Method to use Social Media connections along with Tokens and Systems of Organizations & Point of Transaction Systems to create & execute transaction and post transaction, award compensation to social media companies & participants in transactions

(71) Applicant: Palash Kundu, Pleasanton, CA (US)

(72) Inventor: Palash Kundu, Pleasanton, CA (US)

(73) Assignee: Palash Kundu, Pleasanton, CA (US)

(21) Appl. No.: 19/067,884

(22) Filed: Mar. 1, 2025

(51) Int. Cl. G06Q 30/0234; G06Q 30/0207; G06Q 30/0241; G06Q 50/00

(52) U.S. Cl. CPC G06Q 30/0234; G06Q 10/40; G06Q 30/0222; G06Q 30/0277

(57) ABSTRACT

System and Method will be a platform between Social Media companies, organizations, point of transaction systems and Social Media users. This platform will orchestrate the communication about the potential transactions and benefits to individual participants. Once a participants executes a transaction directly with the organization, this platform will keep record of such transactions. The platform will orchestrate compensation to Social Media companies as well as participants of the transaction which will include the initiator of the communication. The executor of the transaction will get the incentive at time of execution of the transaction. The platform will also orchestrate the setup of registration of organizations who intend to run a campaign as well as register the users who are willing to initiate the communication on behalf of the organizations.

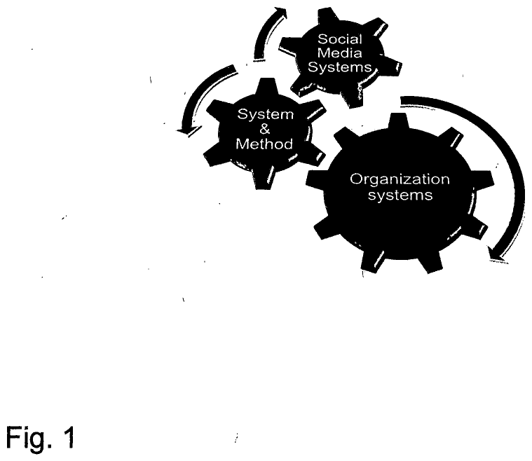

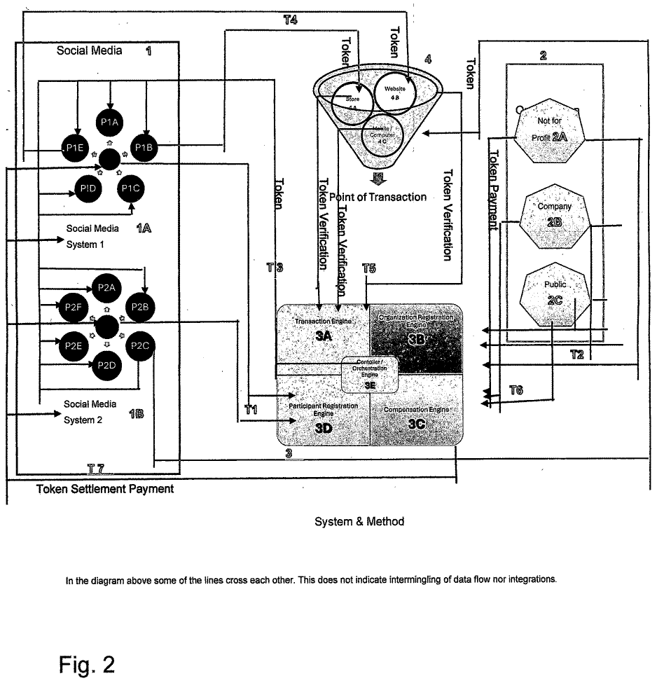

TABLE OF CONTENTS

| | |
|---|---|
| Highlights | 4 |
| Strategic Problem Definition | 4 |
| How this idea solves the problem | 4 |
| Operational Details | 5 |
| Social Media - 1 | 5 |
| Different Types of Social Media | 5 |
| Organization - 2 | 5 |
| Different Types of Organizations | 6 |
| System & Method - 3 | 6 |
| Transaction Engine - 3 A | 6 |
| Organization Registration Engine - 3 B | 6 |
| Compensation Engine - 3 C | 7 |
| Participant Registration Engine - 3 D | 7 |
| Controller/Orchestration Engine - 3 E | 7 |
| Point of Transaction - 4 | 8 |
| Store - 4 A | 8 |
| Website - 4 B | 8 |
| Mobile/Computer - 4 C | 8 |
| Transaction Details | 9 |
| P - 1 & P - 2 (Participants) | 9 |
| T - 1 (Participant Registration) | 9 |
| Opt in - Participant Registration | 9 |
| Opt out - Participant Registration | 10 |
| T - 2 (Organization Registration) | 10 |
| Foundational Data - Organization Registration | 10 |
| Sales/Marketing Campaign Data - Organization Registration | 11 |
| Financial Information - Organization Registration | 11 |
| T - 3 (Sales/Marketing Campaign Communication) | 11 |
| Communication Message - Sales/Marketing Campaign | 11 |
| Communication | |
| Token - Sales/Marketing Campaign Communication | 11 |
| Communication Plan - Sales/Marketing Campaign Communication | 12 |
| T - 4 (Transaction Execution) | 12 |
| T - 5 (Token Verification) | 12 |
| Transaction Execution - Token Verification | 13 |
| Transaction Completion - Token Verification | 13 |
| Transaction Reversal/Change - Token Verification | 13 |
| T - 6 (Token Payment) | 13 |
| Token Reconciliation - Token Payment | 13 |
| Payment - Token Payment | 14 |
| T - 7 (Token Settlement Payment) | 14 |
| Payment to Social Media Companies - Token Settlement Payment | 14 |
| Payment to Participants - Token Settlement Payment | 14 |
| Claims | 15 |
| Drawing Brief Description | 15 |
| FIG. 1 | 15 |
| FIG. 2 | 15 |

### HIGHLIGHTS

### Strategic Problem Definition

Current Advertisement (Ad) based revenue generation for Social Media companies has few deficiencies. Primarily there is upfront cost to organizations that are running the advertisement campaigns with no certainty on the transactions resulting from the ad. Also the connections that social media companies have are not been monetized directly. Lastly there is no direct economic motive for vast majority of social media users to increase and monetize their connections which is currently limited to influencers.

This problem can be extended to include traditional media advertisement campaigns.

### How this Idea Solves the Problem

System and Method will be a platform between Social Media companies, organizations, point of transaction systems and Social Media users. This platform will orchestrate the communication about the potential transactions and benefits to individual participants. Once a participants executes a transaction directly with the organization, this platform will keep record of such transactions. The platform will orchestrate compensation to Social Media companies as well as participants of the transaction which will include the initiator of the communication. The executor of the transaction will get the incentive at time of execution of transaction. The platform will also orchestrate the setup of registration of organizations who intend to run a campaign as well as register the users who are willing to initiate the communication on behalf of the organizations.

### Operational Details

Refer to FIG. 2 of the drawings in the drawings sheet for linking the numbers mentioned below with the numbers in FIG. 2

### Social Media—1

Social Media companies have been dependent on Ad revenue as a revenue stream. The social connections has not been monetized beyond the ad display.

This system & method provides an opportunity for Social Media companies to create a new revenue stream that monetizes the connections directly.

Social Media companies will need to provide access to the System & Method mentioned in this document. This will be in exchange for a part of compensation for the transactions that gets initiated by this System & Method to be paid by the organizations which are the beneficiaries of such transactions. The access needs to be for sending communications to Social Media connections on behalf of principal participant.

The System & Method to be effective will need partnership from at least one Social Media company.

### Different Types of Social Media

1A and 1 B represent two different social media companies in the detailed architecture diagram.
1 A—Social Media Company A (As an example)
1 B—Social Media Company B (As an example)

### Organization—2

Organizations are entities that want consumers to initiate transactions for their offerings. Traditionally organizations run marketing and selling campaigns with Ad's being one of the most important component of delivery of such campaigns.

Ads can be across various mediums like Social Media, TV etc. Major drawback with such campaigns are
Ads have upfront cost
Ads and the transaction it wants to generate are not directly and reliably connected
Ads may not be able to recuperate the amount spend on Ads in the form of transaction value
It might be challenging to hyper focus to target audience
Ads delivery is non personable

### Different Types of Organizations

There can be different types of Organizations. Out of those types three are mentioned here
Not for Profit 2 A—This is a not for profit organization that has offerings for consumers. This can be in form of goods and services as well as other offerings like fund raisings, soliciting for votes, surveys, enrollment for subscriptions etc
Company 2 B—This is a commercial for profit organization that offers goods or services for consumers. Other offerings for Company maybe fund raising, survey etc.
Public 2 C—This is a government or quasi government organization that offers goods, services, informational campaigns like subscription to medical insurance etc

### System & Method—3

System & Method is the platform that encapsulates the idea presented here in this document. This will act as the entity that will partner with Social Media Companies, Organizations that has offerings for consumers and point of transaction systems.

The System & Method consists of the following

### Transaction Engine—3 A

Transaction Engine is the system that partners with Point of Transaction systems. Point of Transaction systems will connect with Transaction Engine to verify the token that is being used by a consumer. In order to verify the token both the token and quantity has to be provided to transaction engine. The transaction engine will verify the token and provide the rebate that is due to the customer.

### Organization Registration Engine—3 B

Organization Registration Engine is the system that partners with Organizations that want to utilize the system & method articulated in this document to execute their marketing and sales campaigns.

Organizations needs to register themselves as well as the offering that they want to promote. For Organization registration key details for connecting with their back end financial systems will be needed. For the offering registration the details for the duration of campaign, incentive offered to Social Media companies, to communication initiators, transaction initiators, system & method mentioned in this document etc has to be registered.

### Compensation Engine—3 C

Compensation Engine is the system that partners with Organizations, Social Media Companies and Participants who initiates the communication for compensation processing. For Organizations the reconciliation of the tokens involved with the transactions in a given period is done and payment due for participants, Social Media Companies and the System & Method mentioned in the document is paid to the Compensation Engine. Compensation Engine after receiving the payment from Organizations will do a payment settlement with the Social Media Companies involved with the transactions that originated from the communication initiated by its users. Also Compensation Engine will do a payment settlement with the Social Media users who had initiated the communication that resulted in transaction/s.

### Participant Registration Engine—3 D

Participant Registration Engine is the system that partners with Social Media Users that want to utilize the system & method articulated in this document to initiate the communication to their connections regarding offerings by Organizations as part of Organization's Marketing and Sales Campaigns.

Participants needs to register themselves as well as the category of offering that they want to promote. For Participants registration key details for connecting with their financial systems will be needed. For the Participant registration the details for the demographic information, the work they do etc has to be registered.

The registration can be conducted in 2 ways. Opt in & Opt Out. Opt in will require Participants to explicitly register themselves in the System & Method mentioned in this document. For Opt Out registration a partnership can be built with Social Media companies that pushes the participant data into the System & Method mentioned in this document based on criteria like demographics, location, number of connections etc.

### Controller/Orchestration Engine—3 E

Controller/Orchestration Engine is the nerve center of the System & Method mentioned in this document. This engine acts as the coordinator between the Organization Registration Engine, Participants Registration Engine, Transaction Engine and Compensation Engine. The data collected in each of these 4 engines mentioned here needs to be shared across the engines which will be accomplished by the Controller/Orchestration Engine. Also the Security and User Administration will be part of this engine. The Reporting solution that will be needed for ongoing tracking and periodic reconciliation will be part of this engine.

The orchestration of campaign communications on behalf of the Social Media Participants who have registered themselves as the initiators for such campaigns will be done by this engine. This will ensure consistency of communication across users in line with the brand and Marketing/Sales Campaign objectives of the Organizations.

### Point of Transaction—4

Point of Transaction is the legacy system where transactions are executed. This System & Method can be operationalized without making significant or in fact any changes to the legacy Point of Transaction.

The token is used to tie the Marketing/Sales Campaign to the Transaction executed in the Point of Transaction systems and onwards to tie it with Organizations and System & Method mentioned in this document for Compensation payment and settlement. The vision is that this should not create any changes or significant changes to existing systems of point of transaction systems as well as backend systems of Organizations.

Point of Transaction systems can be of various types. Out of those types three are mentioned here.

### Store—4 A

Store is a physical location to which a consumer can walk in and perform a transaction. Store here is a generic term and can also include commercial stores, Not for Profit locations, Government locations etc.

### Website—4 B

Website is a virtual location to which a consumer can access to perform a transaction. Website here is a generic term of a virtual location and can also include commercial websites, Not for Profit websites, Government websites, Virtual Reality locations etc.

### Mobile/Computer—4 C

Computer is a device which a consumer uses to perform a transaction. Mobile is a device which a consumer can use to perform a transaction. Mobile here is a generic term of a device and can include phone, Virtual Reality gadgets, hand held gadgets etc.

### Transaction Details

### P-1 & P-2 (Participants)

Participants (P1 & P2) are the Social Media users who leverages their connections to participate in the Marketing/Sales campaigns of the organizations.

The financial incentive for the Participants will be awarded if the token in the communication for Marketing/Sales Campaigns that is sent to their connections is used in any settled transactions. Settled transaction here is to indicate non reversed transactions.

Participants here is used as a generic term and can include person, organizations etc

### T-1 (Participant Registration)

Participant registration is for any social media user who have connections. Participant registration can be carried out in multiple ways. Out of these ways two are mentioned below There are scenarios where the System & Method mentioned in this document will be still valid even if Participants do not register with the System & Method. For e.g. one such scenario will be to partner with Social Media Companies and use the demographic information already available with Social Media Companies. In this scenario the Participants will not register themselves with the System & Method and still the rest of the functionality will work.

Opt in—Participant Registration

In the Opt in Participant Registration a Social Media user will be able to register by providing demographic and financial details. Demographic details will be needed to sync with the Organizations criteria for such details for Sales/Marketing campaigns in order for Participants to engage in such campaigns. The financial details will be needed for the System & Method to make the settlement payment for settled transactions.

Opt in Participant Registration can be executed by multiple ways. Two of such ways is mentioned below
Participants can be encouraged to register themselves directly in the System & Method Participants Registration Engine
In partnership with Social Media companies Participants that meet certain criteria like demographics, location, number of connections etc. can receive a communication from either Social Media companies or System & Method or from Organizations or a combination of these to register themselves in the Participant Registration Engine.
Participants will have the ability to cancel their registration at any time after their registration.

### Opt Out—Participant Registration

In the Opt out Participant Registration a Social Media user will be registered automatically by getting demographic details from the Social Media companies. Participants will have to either provide financial details to System & Method or to Social Media companies for receiving financial payment for any settled transaction that used the token tied to the participant communication.

Participants can be selected for registration based on criteria of demographics, location, number of connections etc.

In Opt out Participant Registration, a participant will be able to cancel their registration at any time after their registration.

### T-2 (Organization Registration)

Organization registration is for any Organization that want to utilize System & Method mentioned in this document to deliver offerings to Social Media users by Sales/Marketing campaigns.

Organization registrations will include basic information about the Organization including the information about the Sales/Marketing Campaign.

There are scenarios where the System & Method mentioned in this document will be still valid even if Organizations do not register with the System & Method. For e.g. one such scenario will be to partner with Organizations and use the information already available with Systems of these Organizations. In this scenario the Organizations will not register themselves with the System & Method and still the rest of the functionality will work.

The key information that will be needed from Organization will be

### Foundational Data—Organization Registration

Foundational data will be the basic information about the Organization.

### Sales/Marketing Campaign Data—Organization Registration

Sales/Marketing Campaign data will include the incentive plan, duration for the campaign, criteria for the participants, communication plan etc

### Financial Information—Organization Registration

Financial Information will include the information needed to reconcile and execute payment for the transactions that were carried out as part of the Sales/Marketing campaigns.

### T-3 (Sales/Marketing Campaign Communication)

Sales/Marketing campaign communication to the Social Media connection of participants can be initiated on behalf of the participants.

This will ensure there is consistency in the communications across all Social Media platforms and across all Social Media users. Also the Organization communication plan that is collected at time of Sales/Marketing campaign registration can be executed in such communications.

The key components of this communication are

### Communication Message—Sales/Marketing Campaign Communication

The communication message can be tailored to various Social Media user attributes as per the communication plan shared by the Organization.

### Token—Sales/Marketing Campaign Communication

Token is used to tie the Sales/Marketing Campaign communication to the transaction executed using the token and onwards with the reconciliation and payment made by the Organization. The same token is also used to make settlement payment made to Social Media companies and participants that initiated the campaign communication. Also token is used for System & Method mentioned in this document to get paid from the Organization for facilitating and orchestrating the entire sequence of events.

Token is a generic word that is used here and is envisioned it to be a key identifier that can be used to trace a transaction to the Social Media Participant in the Sales/Marketing campaign of an Organization.

### Communication Plan—Sales/Marketing Campaign Communication

The communication plan submitted by the Organization will be used to determine the various parameters of the communication. Some of the parameters are given below
Frequency of communication
Psychology techniques to induce reading and action
Financial Incentives
Benchmarking communication with transaction volume
Cultural and Social norms

### T-4 (Transaction Execution)

Token provided in the Sales/Marketing Campaign will be used to execute transaction. The financial incentive for the entity making the transaction can be realized only if the token is used. This will ensure token that was in the Sales/Marketing campaign flows through the various stages of transaction.

Transaction can be made by an entity in various ways. One can be in person transaction in a store as defined in this document. The other way can be transaction made virtually in a website or mobile app or virtual reality application etc

Transaction here is a generic word that can include any transaction to access any offering by any Organizations. Some of the types of transaction are given below for reference.
Sale of goods and Services
Survey
Fund Raising
Government Enrollment
Political Campaigns

### T-5 (Token Verification)

Token Verification process will occur at various stages of lifecycle of a transaction. Some of the stages is given below.

### Transaction Execution—Token Verification

Token provided in the transaction needs to verified with the system and Method mentioned in this document as the entity that is executing the transaction is expecting a financial incentive as part of the transaction. The token needs to be verified along with the quantity if applicable. This also helps in token reconciliation with the Organization during payment settlement process with the Organization.

The quantity is needed along with token for token verification because the financial incentives can change as per the quantities in the transaction.

### Transaction Completion—Token Verification

Once a transaction is completed that confirmation needs to be sent by the system processing the transaction to the System & Method described in this document.

### Transaction Reversal/Change—Token Verification

Similar to transaction completion if the transaction is reversed or changed the system processing the reversal or change needs to send a confirmation to the System & Method described in this document as well.

If the transaction confirmation and/or the transaction change/reversal cannot be communicated by point of transaction to the System & Method mentioned in this document then the same can be communicated by the Organization systems to the System & Method mentioned in this document.

### T-6 (Token Payment)

Token payment process will occur at one of the end stage of lifecycle of a transaction after the transaction is settled. Transaction settlement will happen after the end of period of any return if applicable. Token payment process will involve various activities some of which is mentioned below.

### Token Reconciliation—Token Payment

Token reconciliation needs to happen periodically between the Organization systems and System & Method mentioned in this document. The reconciliation will be pre cursor to the payment to be made by the Organizations.

The reconciliation will be for settled payment.

### Payment—Token Payment

After Token reconciliation payment needs to happen periodically between the Organization systems and System & Method mentioned in this document. The payment will be for incentive due to Social Media companies, participants to the Sales/Marketing Campaigns and System & Method mentioned in this document

### T-7 (Token Settlement Payment)

Token settlement payment process will occur as the end stage of lifecycle of a transaction after the payment is made by the Organization to the System & Method mentioned in this document. Payment will made to multiple entities some of which are mentioned below

### Payment to Social Media Companies—Token Settlement Payment

As the system and method requires partnership with Social Media companies and access to their user base a financial incentive needs to be made to these companies.

The payment will be as per the alignment reached at the time of registration of the Sales/Marketing campaigns by the Organizations. This can be fixed or variable as per the alignment with Organizations.

### Payment to Participants—Token Settlement Payment

As the system and method uses Participants whose behalf the Sales/Marketing campaign is initiated, the payment has to be made to the Participants wherever the communication sent to their connections resulted in a settled transaction. This will keep the Participants incentivized for active participation in Sales/Marketing campaigns of the Organizations. Higher the participation higher will be transactions which lead to higher revenue for Organizations.

### Claims

The following claims are being made based on the specification and drawings given in previous pages.
System and Method to use Social Media connections along with Tokens and Systems of Organizations & Point of Transaction Systems to create & execute transaction and post transaction, award compensation to social media companies & participants in transactions
Incentivize social media users to monetize their social media connections using System and Method to use Social Media connections along with Tokens and Systems of Organizations & Point of Transaction Systems to create & execute transaction and post transaction, award compensation to social media companies & participants in transactions
Use multiple layers of social media connections to orchestrate social media marketing campaigns where each participant is paid compensation for their participation in social media campaign

### DRAWING BRIEF DESCRIPTION

FIG. 1 is the summary architecture diagram
It shows the interaction of the system and method with the social media systems and the organizational systems at a high level.
The system & method will be interacting with social media systems and organizational systems to facilitate the entire transaction life cycle including running marketing campaigns to providing compensation for the participants to the marketing campaigns.

FIG. 2 is the detailed architecture diagram
It shows the interaction of the system and method with the social media systems and the organizational systems at a detailed transaction level.
Social media systems will have social media users and their interactions with other users. The system & method will run the marketing campaigns through these social media users and systems
The organization systems will be the organizations for which marketing campaigns are being run. System & method will interact with the organization systems to register them for campaigns, track the transactions due to the campaigns and facilitate the compensation to be made to various participants involved in the marketing campaigns.

1. System and Method to use Social Media connections along with Tokens and Systems of Organizations & Point of Transaction Systems to create & execute transaction and post transaction, award compensation to social media companies & participants in transactions
Incentivize social media users to monetize their social media connections using System and Method to use Social Media connections along with Tokens and Systems of Organizations & Point of Transaction Systems to create & execute transaction and post transaction, award compensation to social media companies & participants in transactions
Use multiple layers of social media connections to orchestrate social media marketing campaigns where each participant is paid compensation for their participation in social media campaign
